(19) United States
(12) Patent Application Publication
(10) Pub. No.: US 2025/0348687 A1
(43) Pub. Date: Nov. 13, 2025

(54) AI TEXT ANALYSIS SYSTEM TO ACCELERATE ACADEMIC RESEARCH

(71) Applicant: Rajagopal appavu, Tampa, FL (US)

(72) Inventor: Rajagopal appavu, Tampa, FL (US)

(21) Appl. No.: 18/906,272

(22) Filed: Oct. 4, 2024

Related U.S. Application Data
(60) Provisional application No. 63/644,779, filed on May 9, 2024.

(51) Int. Cl. G06F 40/40; G06N 3/0455; G06N 3/096

(52) U.S. Cl. CPC G06F 40/40; G06N 3/0455; G06N 3/096

(57) ABSTRACT

This platform features an AI-based text analysis system centered around a BERT (Bidirectional Encoder Representations from Transformers) model, fine-tuned for analyzing academic and industry literature. It includes a user-friendly interface linked to academic databases, enabling efficient retrieval and detailed analysis of pertinent papers. The enhanced BERT model processes these documents, extracting essential information and generating concise summaries, displayed on an interactive dashboard that highlights literature trends and relationships. The system supports multilingual queries and searches conference presentations, enhancing its versatility. A named entity recognition module identifies critical elements like datasets and methodologies. A standout feature is the integration of a Student Information System (SIS), which incorporates data on students' extracurricular activities related to decision-making. This aids educational institutions and employers by providing insights into students' leadership and problem-solving skills. This comprehensive tool streamlines the literature review process and supports informed decision-making through advanced text analysis and integrated student data.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention belong to others, and the applicants make no claim to any trademarks referenced.

### BACKGROUND OF THE INVENTION

### 1) Field of the Invention

The present disclosure generally relates to the field of artificial intelligence and natural language processing, and more specifically, to systems, methods, and devices that utilize AI-based text analysis for academic research and literature review.

### 2) Description of Related Art

Currently the field of artificial intelligence (AI) and natural language processing (NLP) has seen remarkable advancements in recent years, particularly with the development of sophisticated language models such as the Bidirectional Encoder Representations from Transformers (BERT) model. BERT is a deep learning model developed by Google that has been pre-trained on a large corpus of text, enabling it to understand language with a high degree of accuracy.

In the academic realm, the process of literature review is a foundational aspect of research. It involves the identification, analysis, and synthesis of existing scholarly papers related to a specific research theme. This process is often time-consuming and challenging due to the vast amount of academic literature available.

The traditional approach to literature review involves manual searching and reading of academic papers and presentations, which can be a daunting task for researchers, particularly students. The use of keyword searches and citation chaining are common methods employed in this process. However, these methods are largely dependent on the researcher's knowledge of the field and may not yield a comprehensive review of all relevant literature.

In addition to the manual search process, the analysis of academic research and presentations also presents challenges. Academic writing often involves the use of domain-specific language, referencing styles, and structured paper formats that can be difficult to understand and analyze. Furthermore, the extraction of relevant information from academic papers, such as insights, methodologies, and findings, requires a deep understanding of the scholarly communication language and conventions.

The advent of AI and NLP technologies has opened up new possibilities for automating and enhancing the process of literature review. For instance, AI-based text analysis systems can process large volumes of text data rapidly, extracting relevant information and identifying patterns and relationships within the literature. However, these systems require sophisticated language models, like BERT, that can understand and interpret the nuances of academic research language.

These and other objects, features, and advantages of the present invention will become more readily apparent from the attached drawings and the detailed description of the preferred embodiments, which follow.

### The Problem

In the context of AI-based text analysis systems, user interfaces play a central role in facilitating interaction between the user and the system. These interfaces typically provide mechanisms for inputting search queries and displaying the results of the literature analysis. Furthermore, the integration of these systems with academic databases and research portals is a common feature, allowing users to access a wide range of academic literature.

Despite these advancements, the application of AI and NLP technologies in the field of academic research and literature review is still an active area of research and development. The fine-tuning of language models on academic literature, the development of user-friendly interfaces, and the integration with academic databases and research portals are among the ongoing efforts in this field.

Bearing in mind the problems and deficiencies of the prior art, it is therefore an object of the present invention to provide an AI-based text analysis system primarily seeks to solve the problem of a time-consuming and intimidating task involved in literature review for a student researcher. It has become difficult for students to locate, scrutinize, and synthesize all significant-high-quality papers that are associated with their research themes due to the ever-increasing academic publications.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, the system includes an AI-based text analysis system for academic literature review. This system includes a BERT model (BERT language model is an open source machine learning framework for natural language processing (NLP)), fine-tuned on academic research, a user interface for inputting search queries, a connection to academic databases for retrieving relevant papers based on the search queries, and a processing unit for analyzing the retrieved papers using the fine-tuned BERT model to extract relevant information and generate summaries.

An additional embodiment can be a two part search first for potentially relevant databases which the user can then select from, and then second a thorough search of academic databases

According to other aspects of the present disclosure, the system may include one or more of the following features. The user interface may further include a dashboard for displaying the summaries and extracted insights. The dashboard may further include interactive visualizations for displaying relationships within the literature. Examples of visualization include scatter charts, bubble charts and bar charts. The BERT model may be further fine-tuned to understand academic language and jargon specific to various academic disciplines. The processing unit may further include a sentiment analysis module for identifying sentiments in the retrieved papers. The connection to academic databases may further include an API for seamless retrieval of papers from multiple databases. The processing unit may further include a named entity recognition module for identifying entities such as datasets, methods, and algorithms in the retrieved papers.

According to another aspect of the present disclosure, the method includes conducting academic literature review using an AI-based text analysis system. This method includes the steps of inputting a search query through a user interface, retrieving relevant papers from academic databases based on the search query, processing the retrieved papers using a BERT model fine-tuned on academic literature to extract relevant information, and generating summaries of the processed papers.

According to another aspect of the invention, in addition to English, searches may be also be conducted in foreign languages, specifically Russian, Chinese and Japanese.

According to another aspect of the invention the AI search system will first search for applicable data bases, and then secondarily do a search within those databases.

According to other aspects of the present disclosure, the method may include one or more of the following steps. The search query may include keywords related to a specific academic discipline. The BERT model may be further fine-tuned based on the specific academic discipline related to the keywords in the search query. The step of retrieving relevant papers may further include sorting the retrieved papers based on relevance to the search query. The step of processing the retrieved papers may further include identifying entities such as datasets, methods, and algorithms in the retrieved papers. The step of generating summaries may further include generating visual representations of relationships within the literature. The method may further include the step of displaying the summaries and extracted insights on a user interface.

According to yet another aspect of the present disclosure, the system includes an AI-based text analysis system for academic research and literature review. This system includes a BERT model fine-tuned on academic literature, a user interface for inputting specific papers or links to academic databases, a processing unit for analyzing the inputted papers using the fine-tuned BERT model to extract relevant information and generate summaries, and a display unit for presenting the generated summaries and extracted information in an intuitive format.

According to other aspects of the present disclosure, the system may include one or more of the following features. The user interface may further include a feature for refining search queries based on user feedback. The feature for refining search queries may include a mechanism for adjusting the relevance of search results based on user interactions with the system. The BERT model may be further fine-tuned to understand academic language and jargon specific to various academic disciplines. The processing unit may further include a sentiment analysis module for identifying sentiments in the inputted papers. The display unit may further include interactive visualizations for displaying relationships within the literature.

### Search Sequence in the Platform System

### User Inputs Keywords into the Dashboard

The student, schoolers”, Conference, Patent, Publication, Google Scholar Citation etc). teacher, college admission counselors or administrator logs into the Platform System and enters keywords in the search bar (e.g., “extracurricular activities in AI,” “STEM research for middle.

### Platform System Suggests Keywords

The Platform System immediately processes the initial keyword query and generates a list of alternative or related keywords using an AI-based algorithm. The Platform System ranks these alternative keywords based on relevance and previous successful searches, presenting a range from most to least relevant suggestions.

Example: If the user searches for “AI research,” the system might return suggestions such as “machine learning projects,” “deep learning competitions,” or “student-led AI workshops.”

User Selects the Most Appropriate Keywords: The user refines their query by selecting the most suitable alternative keywords provided by the Platform System or sticking with the original search term. The Platform System provides feedback, indicating how certain keyword selections may narrow or broaden the scope of the search.

Example: If a student is interested in narrowing down their AI research search to machine learning, they can select that keyword, and the platform will narrow the results accordingly.

Platform System Begins the Search: The Platform System executes a full search based on the final keyword selection. It searches through the system's internal data (student profiles, research projects, research publication, research citations, conference abstract, patents, STEM/STEAM competition wins, Olympiads, County level competitions, State level competitions, International level competitions, grants/awards, Personal Statement, College Essay, SAT Score, ACT Score, GPA, MCAT Score etc, other extracurricular activities etc.) and external academic databases, returning a ranked list of results.

The search results include detailed summaries or abstracts, along with student profiles and projects that match the chosen keywords. Additionally, the Platform System can suggest collaboration opportunities by linking students working on similar projects.

Continuous Refinement Based on User Interactions: As users interact with the search results (e.g., clicking on certain projects, dismissing irrelevant ones), the Platform System adjusts future search suggestions, learning from user preferences to improve relevance.

### Benefits of This Approach

Improved Search Precision: By offering intelligent keyword suggestions and continuous feedback, users are more likely to find the right research projects or activities.

Personalized Results: The system's ability to cross-reference profiles and projects ensures that the results are highly tailored to each user's goals.

Collaboration and Networking: The system's integration of profiles allows students to connect with peers on similar paths, fostering collaboration.

Support for Pre-University Exams and Admissions (Undergraduate and Postgraduate): The platform can play a pivotal role in preparing students for pre-university exams (like SAT, ACT, or other country-specific standardized tests) by aligning their academic and extracurricular activities with the expectations of competitive admissions processes. By offering:
a. Targeted Study and Research Opportunities: Students can find relevant projects, competitions, or research that directly impact their readiness for entrance exams or academic interviews.
b. Profile Building: The SIS helps students curate a well-rounded portfolio by highlighting relevant extracurriculars, research experiences, and academic achievements that admissions officers value. This is crucial for both undergraduate and postgraduate applications.
c. Admissions Guidance: The system can also provide keyword-based recommendations for courses, exams, or additional qualifications that might enhance a student's chance of success in top-tier programs.
d. Enhanced College and Scholarship Applications: By compiling all relevant research, projects, and extracurricular activities through intelligent search mechanisms, the SIS supports comprehensive college and scholarship applications. It helps students showcase their achievements, linking them to specific research or skills that match the criteria sought by universities or scholarship committees.

In this way, the platform becomes not only a research tool but a strategic resource for students navigating the challenging paths of pre-university exams, undergraduate, and postgraduate admissions.

The foregoing general description of the illustrative embodiments and the following detailed description thereof are merely exemplary aspects of the teachings of this disclosure and are not restrictive.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, the system includes an AI-based text analysis system for academic research and literature review. This system includes a BERT model fine-tuned on academic research and literature, a user interface for inputting search queries, a connection to academic databases for retrieving relevant papers based on the search queries, and a processing unit for analyzing the retrieved papers using the fine-tuned BERT model to extract relevant information and generate summaries.

According to other aspects of the present disclosure, the Platform and System may include one or more of the following features. The user interface may further include a dashboard for displaying the summaries and extracted insights. The dashboard may further include interactive visualizations for displaying relationships within the literature. The BERT model may be further fine-tuned to understand academic language and jargon specific to various academic disciplines. The processing unit may further include a sentiment analysis module for identifying sentiments in the retrieved papers. The connection to academic databases may further include an API for seamless retrieval of papers from multiple databases. The processing unit may further include a named entity recognition module for identifying entities such as datasets, methods, and algorithms in the retrieved papers.

According to another aspect of the present disclosure, the method includes conducting academic research and literature review using an AI-based text analysis system. This method includes the steps of inputting a search query through a user interface, retrieving relevant papers from academic databases based on the search query, processing the retrieved papers using a BERT model fine-tuned on academic research and literature to extract relevant information, and generating summaries of the processed papers.

According to other aspects of the present disclosure, the method may include one or more of the following steps. The search query may include keywords related to a specific academic discipline. The BERT model may be further fine-tuned based on the specific academic discipline related to the keywords in the search query. The step of retrieving relevant papers may further include sorting the retrieved papers based on relevance to the search query. The step of processing the retrieved papers may further include identifying entities such as datasets, methods, and algorithms in the retrieved papers. The step of generating summaries may further include generating visual representations of relationships within the literature. The method may further include the step of displaying the summaries and extracted insights on a user interface.

According to yet another aspect of the present disclosure, the system includes an AI-based text analysis system for academic research and literature review. This system includes a BERT model fine-tuned on academic literature, a user interface for inputting specific papers or links to academic databases, a processing unit for analyzing the inputted papers using the fine-tuned BERT model to extract relevant information and generate summaries, and a display unit for presenting the generated summaries and extracted information in an intuitive format.

According to other aspects of the present disclosure, the system may include one or more of the following features. The user interface may further include a feature for refining search queries based on user feedback. The feature for refining search queries may include a mechanism for adjusting the relevance of search results based on user interactions with the system. The BERT model may be further fine-tuned to understand academic language and jargon specific to various academic disciplines. The processing unit may further include a sentiment analysis module for identifying sentiments in the inputted papers. The display unit may further include interactive visualizations for displaying relationships within the literature.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention which is directed to an AI-based text analysis system for academic literature review, comprising:
a. a BERT model fine-tuned on academic literature;
b. a user interface for inputting search queries;
c. a connection to academic databases for retrieving relevant papers based on the search queries; and
d. a processing unit for analyzing the retrieved papers using the fine-tuned BERT model to extract relevant information and generate summaries.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a flow chart of the AI Text Analysis System to Accelerate Academic Research;

FIG. 2 shows how the AI-based text analysis system works regarding applying for college admission, utilizing all available information resources

FIG. 3 shows the difference computing time between pre-training and fine tuning a BERT Model. Pre-training fine-tuning and the BERT Model are all standard industry terms. The process of this application calls for fine tuning the BERT. Pre-training the BERT Model is done with standard databases such as Wikipedia and other popular book sources and many other databases that are available through the BERT Model providers, such as Google or Allen AI. Fine-tuning is changing the application to search fewer resources on smaller datasets to optimize its performance on specific tasks such as academic research, industry conferences, or industry research.

FIG. 4 shows the Student's information module which stores and manages student data, including academic records and extracurricular activities and manages he information flow between the Student's Dashboard, and the AI system utilizing the Bert Model. The student information model is a really a BERT Model AI front end interface that allows the user to process queries and read responses in understandable text.

The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

This is an outline of an Information Technology Architecture for connecting academic databases with a student information system, incorporating user interfaces, dashboards, and AI capabilities. Note the system of this application includes the use of outside servers, and the use of the computing capability of an individual computer, both are include. The individual computer will only be practical for narrow searches. This architecture includes This is a high-level overview of such a system:

### IT Architecture: Academic Database and SIS Integration

A breakdown of the components and processes in this architecture:
a. User Interface:
b. Web-based responsive interface accessible via browsers and mobile devices;
c. Built using modern frontend frameworks like React or Vue.js.
d. API Gateway:
e. Handles incoming requests and routes them to appropriate services;
f. Implements rate limiting, caching, and security features.
g. Authentication & Authorization:
h. Manages user authentication and role-based access control;
i. Integrates with the institution's Single Sign-On (SSO) system.
j. Load Balancer:
k. Distributes incoming traffic across multiple application servers;
l. Ensures high availability and scalability.
m. Application Servers:
n. Hosts the core business logic and application functionality;
o. Handles data processing, search requests, and integration with other components.

### AI Module (BERT)

a. Utilizes BERT (Bidirectional Encoder Representations from Transformers) for natural language processing tasks;
b. Enhances search capabilities and provides intelligent recommendations.

### Data Integration Layer

c. Manages connections and data flow between various data sources;
d. Implements ETL (Extract, Transform, Load) processes for data synchronization.

### Student Information System (SIS)

e. Stores and manages student data, including academic records and extracurricular activities;
f. Provides APIs for data retrieval and updates.

### Academic Databases

g. Integration with PubMed, Google Scholar, and JASS@STEM through their respective APIs;
h. Enables search and retrieval of academic publications and research data.

### Dashboard

i. Presents personalized information to students based on their academic profile and interests;
j. Displays relevant research papers, academic performance, and extracurricular activities.

### Platform and System

k. Cloud Infrastructure: Deploy on a cloud platform like AWS, Azure, or Google Cloud for scalability and reliability;
l. Containerization: Use Docker for containerizing application components;
m. Orchestration: Implement Kubernetes for container orchestration and management;
n. Database: Utilize a combination of relational (e.g., PostgreSQL) and NoSQL (e.g., MongoDB) databases for different data types;
o. Caching: Implement Redis for caching frequently accessed data;
p. Message Queue: Use Apache Kafka or RabbitMQ for asynchronous communication between components.

### Process Flow

q. Student logs in through the user interface;
r. Request passes through API Gateway and Authentication service;
s. Load Balancer directs the request to an available Application Server;
t. Application Server processes the request, interacting with the SIS and Academic Databases as needed;
u. BERT AI module enhances search results and provides recommendations;
v. Dashboard is generated with personalized information;
w. Response is sent back to the user interface for display

This architecture allows for seamless integration of academic databases with the student information system, providing a comprehensive platform for students to access their academic information, search for relevant research, and track their extracurricular activities.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that while the features and advantages of the invention are illustrated in terms of an AI-based text analysis system for academic literature review.

The following description sets forth exemplary aspects of the present disclosure. It should be recognized, however, that such a description is not intended as a limitation on the scope of the present disclosure. Rather, the description also encompasses combinations and modifications to those exemplary aspects described herein.

The present disclosure relates to a system and method for conducting academic literature review using artificial intelligence (AI). In particular, the present disclosure may provide a system and method for analyzing and summarizing academic literature using a fine-tuned Bidirectional Encoder Representations from Transformers (BERT) model. Further, according to particular aspects of the present disclosure, the system may include a user interface for inputting search queries or specific papers, a connection to academic databases for retrieving relevant papers, and a processing unit for analyzing the retrieved papers and generating summaries.

More specifically, the AI-based text analysis system of the present disclosure may include a BERT model fine-tuned on academic research and literature, a user interface for inputting search queries or specific papers, a processing unit for analyzing the inputted papers, and a display unit for presenting the generated summaries and extracted information. The fine-tuned BERT model may allow the system to understand academic research language and jargon specific to various academic disciplines. In addition, the processing unit may include a sentiment analysis module for identifying sentiments in the inputted papers and a named entity recognition module for identifying entities such as datasets, methods, and algorithms in the retrieved papers.

The method for conducting academic research and literature review using the AI-based text analysis system may include the steps of inputting a search query or specific papers through a user interface, retrieving relevant papers from academic databases based on the search query or specific papers, processing the retrieved papers using a BERT model fine-tuned on academic research and literature to extract relevant information, and generating summaries of the processed papers. The method may also include the step of displaying the summaries and extracted insights on a user interface.

The AI-based text analysis system and method of the present disclosure may provide several technical benefits. For instance, the system and method may save time and energy for students conducting literature review by processing a large amount of literature within a short time. The system and method may also improve the quality and breadth of research conducted by providing comprehensive and nuanced analysis of scholarly documents. Furthermore, the system and method may enhance the user's understanding of their research topic by identifying connections and themes across papers and highlighting strengths and weaknesses in each study.

The AI-based text analysis system for academic literature review, in some aspects, may comprise several main components. One of these components may be a BERT model. In some cases, this BERT model may be fine-tuned on academic literature. This fine-tuning process may involve training the BERT model on a large corpus of academic research texts, allowing the model to learn the specific language, structure, and nuances of academic writing. This fine-tuning may enhance the model's ability to understand and analyze academic research and literature, thereby improving the accuracy and relevance of the system's analysis and summaries.

Another component of the system may be a user interface. In some cases, this user interface may be used for inputting search queries. These search queries may include keywords or phrases related to a specific academic discipline or research topic. The user interface may be designed to be intuitive and user-friendly, facilitating easy input of search queries by users.

The system may also include a connection to academic research and literature databases. In some aspects, this connection may be used for retrieving relevant papers based on the search queries inputted through the user interface. The system may connect to one or more academic databases, allowing it to access a wide range of academic research and literature across various disciplines. The system may retrieve papers that are relevant to the search query, ensuring that the analysis and summaries generated by the system are pertinent to the user's research topic.

A processing unit may also be included in the system. In some cases, this processing unit may analyze the retrieved papers using the fine-tuned BERT model. The processing unit may extract relevant information from the papers, such as the main findings, methodologies used, datasets employed, and other pertinent details. Based on this analysis, the processing unit may generate summaries of the papers. These summaries may provide a concise overview of the papers, allowing users to quickly understand the main points and findings of the papers without having to read them in their entirety.

In some aspects, the user interface of the AI-based text analysis system may include a dashboard. This dashboard may be configured to display the summaries and extracted insights generated by the system. The summaries may provide a concise overview of the main points and findings of the analyzed papers, while the extracted insights may highlight pertinent details such as the methodologies used, datasets employed, and other relevant information. The dashboard may present this information in an organized and intuitive manner, facilitating easy comprehension and review by the user.

In some cases, the user interface may be used for inputting search queries. These search queries may include keywords related to a specific academic discipline or research topic. The system may process these search queries and retrieve relevant papers from academic research databases based on the keywords. This functionality may allow users to easily locate and access academic literature that is pertinent to their research topic.

In other aspects, the user interface of the AI-based text analysis system may be used for inputting specific papers or links to academic research databases, instead of inputting search queries. This functionality may provide users with the flexibility to directly input papers that they have already identified as relevant to their research. The system may then analyze these inputted papers using the fine-tuned BERT model and generate summaries and extracted insights.

Furthermore, the user interface of the AI-based text analysis system may include a feature for refining search queries based on user feedback. This feature may allow users to adjust their search queries in response to the results generated by the system. For instance, if a user finds that the retrieved papers are not sufficiently relevant to their research topic, they may refine their search query to include more specific keywords or exclude irrelevant terms. This feature may enhance the relevance and accuracy of the system's search results, thereby improving the efficiency and effectiveness of the literature review process.

In some aspects, the user interface of the AI-based text analysis system may include a dashboard. This dashboard may be configured to display interactive visualizations. These visualizations may be designed to display relationships within the literature. For instance, the visualizations may show connections between different papers, such as shared methodologies, datasets, or findings. The visualizations may also highlight trends or patterns in the literature, such as common themes or recurring research gaps. These interactive visualizations may provide users with a visual and intuitive understanding of the literature, facilitating their comprehension and analysis of the research field.

In other cases, the display unit of the AI-based text analysis system may include interactive visualizations for displaying relationships within the literature. These visualizations may be generated based on the analysis and summaries produced by the system. For example, the system may generate a network diagram showing the connections between different papers based on shared methodologies or findings. The system may also generate a timeline showing the progression of research in a particular field over time. These visualizations may provide users with a visual and intuitive understanding of the literature, facilitating their comprehension and analysis of the research field.

In some aspects, the BERT model may be further fine-tuned to understand academic language and jargon specific to various academic disciplines. This additional fine-tuning process may involve training the BERT model on a corpus of academic research texts from a specific discipline, such as physics, biology, or sociology. This discipline-specific training may enable the BERT model to learn the specific language, terminology, and conventions used in that discipline, thereby enhancing its ability to accurately analyze and summarize academic literature from that discipline.

In some cases, the BERT model may be further fine-tuned based on the specific academic research discipline related to the keywords in the search query. For instance, if a user inputs a search query related to the field of neuroscience, the BERT model may be fine-tuned using a corpus of neuroscience literature. This fine-tuning process may enhance the BERT model's understanding of the language, terminology, and conventions used in neuroscience literature, thereby improving the relevance and accuracy of the system's analysis and summaries for that specific search query.

In other aspects, the BERT model of the AI-based text analysis system may be fine-tuned to understand academic research language and jargon specific to various academic research disciplines. This fine-tuning process may involve training the BERT model on a corpus of academic research texts from a range of disciplines. This multi-disciplinary training may enable the BERT model to learn the specific language, terminology, and conventions used across various academic disciplines, thereby enhancing its ability to accurately analyze and summarize academic research and literature from a wide range of fields. This multi-disciplinary fine-tuning may provide the system with the flexibility to analyze and summarize academic research and literature from any discipline, making it a versatile tool for conducting literature reviews across a broad spectrum of research topics.

The processing unit of the AI-based text analysis system may include several modules that enhance its ability to analyze and summarize academic research and literature. In some aspects, the processing unit may include a sentiment analysis module. This sentiment analysis module may be used for identifying sentiments in the retrieved papers. For instance, the sentiment analysis module may analyze the tone of the text in the papers, identifying whether the text expresses positive, negative, or neutral sentiments. This sentiment analysis may provide additional insights into the papers, such as the authors' attitudes towards the research topic or the general sentiment in the academic research community regarding a particular issue.

In some cases, the processing unit may also include a named entity recognition module. This named entity recognition module may be used for identifying entities such as datasets, methods, and algorithms in the retrieved papers. For example, the named entity recognition module may scan the text of the papers and identify mentions of specific datasets, research methods, or algorithms. This named entity recognition may facilitate the extraction of relevant information from the papers, enhancing the comprehensiveness and accuracy of the system's analysis and summaries.

In other aspects, the processing unit of the AI-based text analysis system may include a sentiment analysis module for identifying sentiments in the inputted papers. This sentiment analysis module may analyze the tone of the text in the inputted papers, identifying whether the text expresses positive, negative, or neutral sentiments. This sentiment analysis may provide additional insights into the inputted papers, such as the authors' attitudes towards the research topic or the general sentiment in the academic research community regarding a particular issue. This functionality may enhance the relevance and accuracy of the system's analysis and summaries, thereby improving the efficiency and effectiveness of the literature review process.

In some aspects, the AI-based text analysis system may establish a connection to academic research databases. This connection may facilitate the retrieval of relevant papers based on the search queries inputted through the user interface or the specific papers or links to academic research databases provided by the user. The system may connect to one or more academic research databases, allowing it to access a wide range of academic research and literature across various disciplines. The system may retrieve papers that are relevant to the search query, or the specific papers or links provided by the user, ensuring that the analysis and summaries generated by the system are pertinent to the user's research topic.

In some cases, the connection to academic research databases may include an Application Programming Interface (API) for seamless retrieval of papers from multiple databases. The API may provide a standardized protocol for requesting and receiving data from the academic research databases. This may allow the system to retrieve papers from multiple databases in a consistent and efficient manner, regardless of the specific structure or format of each database. The use of an API may enhance the system's ability to access a wide range of academic research and literature, thereby improving the breadth and comprehensiveness of its analysis and summaries.

In other aspects, the system may connect to academic research databases using other methods or protocols. For instance, the system may connect to databases using direct database queries, web scraping techniques, or other data retrieval methods. Regardless of the specific method used, the system may be configured to retrieve relevant papers from academic research databases based on the search queries inputted through the user interface or the specific papers or links provided by the user. This functionality may provide the system with the flexibility to access a wide range of academic research and literature, thereby enhancing its ability to conduct comprehensive and accurate literature reviews.

In some aspects, the method for conducting academic research and literature review using the AI-based text analysis system may involve several steps. One of these steps may be inputting a search query through a user interface. This search query may include keywords or phrases related to a specific academic discipline or research topic. The user interface may be designed to be intuitive and user-friendly, facilitating easy input of search queries by users.

In some cases, the method may involve retrieving relevant papers from academic research databases based on the search query. The system may connect to one or more academic databases, allowing it to access a wide range of academic research and literature across various disciplines. The system may retrieve papers that are relevant to the search query, ensuring that the analysis and summaries generated by the system are pertinent to the user's research topic.

In other aspects, the method may involve processing the retrieved papers using a BERT model fine-tuned on academic research. The processing unit may analyze the retrieved papers using the fine-tuned BERT model, extracting relevant information such as the main findings, methodologies used, datasets employed, and other pertinent details. Based on this analysis, the processing unit may generate summaries of the papers. These summaries may provide a concise overview of the papers, allowing users to quickly understand the main points and findings of the papers without having to read them in their entirety.

In some cases, the method may involve generating summaries of the processed papers. The processing unit may generate these summaries based on the analysis of the retrieved papers. The summaries may provide a concise overview of the main points and findings of the papers, facilitating easy comprehension and review by the user. The summaries may be presented in an organized and intuitive manner, facilitating easy comprehension and review by the user.

In some aspects, the method for conducting academic research and literature review using the AI-based text analysis system may involve the step of retrieving relevant papers from academic databases. This retrieval process may be based on the search query inputted through the user interface or the specific papers or links to academic research databases provided by the user. The system may connect to one or more academic research databases, allowing it to access a wide range of academic research and literature across various disciplines. The system may retrieve papers that are relevant to the search query, or the specific papers or links provided by the user, ensuring that the analysis and summaries generated by the system are pertinent to the user's research topic.

In some cases, the step of retrieving relevant papers may further comprise sorting the retrieved papers based on relevance to the search query. The system may use various criteria to determine the relevance of the papers to the search query, such as the frequency of the search keywords in the papers, the date of publication of the papers, the citation count of the papers, or other relevant factors. The system may then sort the retrieved papers based on these criteria, presenting the papers in an order that reflects their relevance to the search query. This sorting process may enhance the efficiency of the literature review process, as it may allow the user to focus on the papers that are likely to be the most relevant to their research topic.

In other aspects, the system may use other methods or algorithms for sorting the retrieved papers based on relevance to the search query. For instance, the system may use machine learning algorithms to predict the relevance of the papers to the search query based on various features of the papers, such as the abstract of the papers, the keywords of the papers, the authors of the papers, or other relevant features. Regardless of the specific method used, the system may be configured to sort the retrieved papers based on relevance to the search query, thereby enhancing the relevance and accuracy of the system's analysis and summaries.

In some aspects, the processing of the retrieved papers may involve identifying entities such as datasets, methods, and algorithms. This identification process may be conducted by a named entity recognition module included in the processing unit. The named entity recognition module may scan the text of the retrieved papers and identify mentions of specific datasets, research methods, or algorithms. This identification of entities may facilitate the extraction of relevant information from the papers, enhancing the comprehensiveness and accuracy of the system's analysis and summaries.

In some cases, the step of processing the retrieved papers may further comprise identifying entities in the retrieved papers. This identification process may involve scanning the text of the papers and identifying mentions of specific entities such as datasets, methods, and algorithms. The system may use various techniques or algorithms for named entity recognition, such as machine learning algorithms, rule-based methods, or other suitable techniques. This identification of entities may provide additional insights into the papers, such as the specific datasets used in the research, the methods employed in the studies, or the algorithms developed or used in the papers.

In other aspects, the processing of the retrieved papers may involve other types of text analysis or information extraction. For instance, the system may perform sentiment analysis to identify the sentiments expressed in the papers, keyword extraction to identify the main topics or themes of the papers, or other types of text analysis. Regardless of the specific methods used, the system may be configured to process the retrieved papers using the fine-tuned BERT model and extract relevant information, thereby enhancing the relevance and accuracy of the system's analysis and summaries.

In some aspects, the generation of summaries may involve creating visual representations of relationships within the literature. The processing unit may generate these visual representations based on the analysis of the retrieved papers. For instance, the processing unit may create a network diagram showing the connections between different papers based on shared methodologies or findings. The processing unit may also generate a timeline showing the progression of research in a particular field over time. These visual representations may provide users with a visual and intuitive understanding of the literature, facilitating their comprehension and analysis of the research field.

In some cases, the step of generating summaries may further comprise generating visual representations of relationships within the literature. These visual representations may be created based on the analysis and summaries produced by the system. For example, the system may generate a network diagram showing the connections between different papers based on shared methodologies or findings. The system may also generate a timeline showing the progression of research in a particular field over time. These visual representations may provide users with a visual and intuitive understanding of the literature, facilitating their comprehension and analysis of the research field.

In other aspects, the generation of summaries may involve other types of visual representations or data visualizations. For instance, the system may generate a word cloud showing the frequency of keywords in the retrieved papers, a bar chart showing the distribution of papers across different research topics, or other types of visual representations. Regardless of the specific type of visual representation used, the system may be configured to generate summaries that include visual representations of relationships within the literature, thereby enhancing the comprehensiveness and intuitiveness of the system's analysis and summaries.

In some aspects, the method for conducting academic research and literature review using the AI-based text analysis system may further comprise the step of displaying the summaries and extracted insights on a user interface. This user interface may be part of the system's dashboard, which may be designed to present the summaries and extracted insights in an organized and intuitive manner. The summaries may provide a concise overview of the main points and findings of the analyzed papers, while the extracted insights may highlight pertinent details such as the methodologies used, datasets employed, and other relevant information. The user interface may present this information in a manner that facilitates easy comprehension and review by the user.

In some cases, the user interface may include interactive visualizations for displaying relationships within the literature. These visualizations may be generated based on the analysis and summaries produced by the system. For example, the system may generate a network diagram showing the connections between different papers based on shared methodologies or findings. The system may also generate a timeline showing the progression of research in a particular field over time. These visualizations may provide users with a visual and intuitive understanding of the literature, facilitating their comprehension and analysis of the research field.

In other aspects, the user interface may include a feature for refining search queries based on user feedback. This feature may allow users to adjust their search queries in response to the results generated by the system. For instance, if a user finds that the retrieved papers are not sufficiently relevant to their research topic, they may refine their search query to include more specific keywords or exclude irrelevant terms. This feature may enhance the relevance and accuracy of the system's search results, thereby improving the efficiency and effectiveness of the literature review process.

In some cases, the user interface may be used for inputting specific papers or links to academic research databases, instead of inputting search queries. This functionality may provide users with the flexibility to directly input papers that they have already identified as relevant to their research. The system may then analyze these inputted papers using the fine-tuned BERT model and generate summaries and extracted insights. These summaries and insights may then be displayed on the user interface, providing users with a comprehensive and intuitive overview of the analyzed literature.

In some aspects, the AI-based text analysis system may be configured to accept specific papers or links to academic research databases as input, instead of search queries. This functionality may provide users with the flexibility to directly input papers that they have already identified as relevant to their research. The system may then analyze these inputted papers using the fine-tuned BERT model and generate summaries and extracted insights. This approach may be particularly useful for users who have already conducted a preliminary literature search and have identified specific papers that they wish to analyze in more detail.

In some cases, the inputted papers or links may be provided through the user interface of the AI-based text analysis system. The user interface may be designed to facilitate easy input of specific papers or links, allowing users to quickly and conveniently provide the system with the materials they wish to analyze. The user interface may also include features for managing and organizing the inputted papers or links, such as a feature for categorizing the papers by topic, author, publication date, or other relevant criteria.

In other aspects, the AI-based text analysis system may include a display unit for presenting the generated summaries and extracted information. The display unit may be configured to present the summaries and extracted information in an intuitive format, facilitating easy comprehension and review by the user. The display unit may include various features for enhancing the presentation of the summaries and extracted information, such as interactive visualizations, sortable tables, or other suitable features. The display unit may also include features for customizing the presentation of the summaries and extracted information, such as a feature for adjusting the level of detail in the summaries, a feature for highlighting specific pieces of extracted information, or other suitable features.

In some aspects, the user interface of the AI-based text analysis system may include a feature for refining search queries based on user feedback. This feature may allow users to adjust their search queries in response to the results generated by the system. For instance, if a user finds that the retrieved papers are not sufficiently relevant to their research topic, they may refine their search query to include more specific keywords or exclude irrelevant terms. This feature may enhance the relevance and accuracy of the system's search results, thereby improving the efficiency and effectiveness of the literature review process.

In some cases, the feature for refining search queries may include a mechanism for adjusting the relevance of search results based on user interactions with the system. For example, the system may track the user's interactions with the search results, such as which papers the user chooses to view or download, and use this information to adjust the relevance of the search results. This may involve re-ranking the search results based on the user's interactions, promoting papers that are similar to those the user has shown interest in and demoting papers that are similar to those the user has ignored. This mechanism may provide a personalized search experience, tailoring the search results to the user's specific interests and research goals.

In other aspects, the mechanism for adjusting the relevance of search results may use other types of user feedback or interactions. For instance, the system may allow the user to provide explicit feedback on the relevance of the search results, such as rating the relevance of each paper or providing comments on the search results. The system may then use this explicit feedback to adjust the relevance of the search results, promoting papers that the user has rated as relevant and demoting papers that the user has rated as irrelevant. This explicit feedback mechanism may provide a more direct and accurate way of tailoring the search results to the user's specific interests and research goals.

Regardless of the specific methods used, the feature for refining search queries and the mechanism for adjusting the relevance of search results may work together to enhance the relevance and accuracy of the system's search results. This may improve the efficiency and effectiveness of the literature review process, allowing users to quickly and accurately locate relevant academic research and literature for their research.

A number of implementations have been described. Nevertheless, it will be understood that various modifications may be made without departing from the spirit and scope of the disclosure. Accordingly, other implementations are within the scope of the following claims.

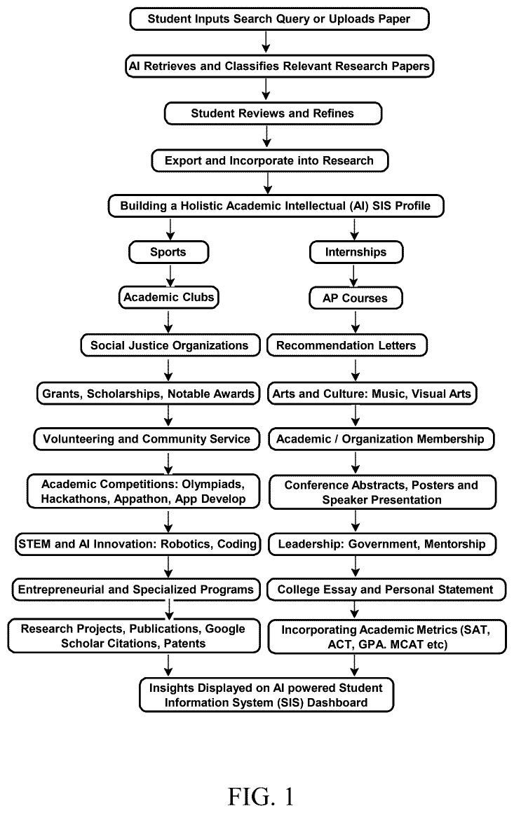

Referring now to the drawings FIG. 1-4, and more particularly to FIG. 1, FIG. 1 is a flow chart of the AI Text Analysis System to Accelerate Academic research. The process flow can be described as follows:

In this, the student submits a search term or uploads a specific paper into the system via the research portal dashboard.

Based on the search term or paper subject, the AI system retrieves appropriate papers from academic research databases and repositories.

These retrieved papers are then processed by a BERT AI model fine-tuned on scholarly literature.

This model performs some key operations:
a. Sorts out papers into relevant topic areas and subtopics.
b. Extract essential insights, findings, and contributions from each paper.
c. Identify important entities like datasets, methods, and algorithms.
d. Produce crisp yet informative expert-level summaries that capture the gist of each paper.

In an intuitive format presented to students via their research portal dashboards are; results of artificial intelligence-generated items such as topic classification, extracted insights, keywords, and summaries.

A student who sees the initial results has two alternatives:
a. Revise their search query or submit more papers for analysis, which initiates another cycle of processing by the BERT AI.
b. Export summaries and insights that appear satisfactory to them into their literature review.

Through AI-assisted literature analysis, this student accomplishes an efficient overall review to serve as a solid basis for his/her research project or essay.

This flow chart shows key activities and decision points in the AI-supported literature review process with a focus on iterative searches' refinement and AIs being inserted in students' research process.

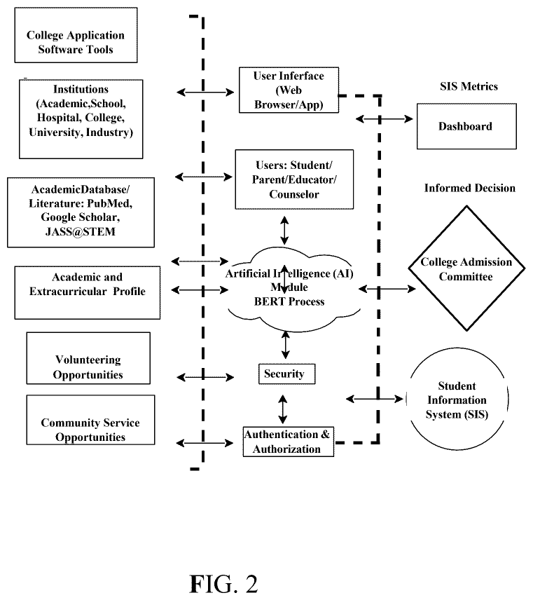

Referring to FIG. 2 shows the BERT framework architecture of the instant invention.

This purposeful structure is connected to popular databases and study gateways so that there is not even the slightest hitch in reaching as many educational materials as possible. This way, one can ask for papers directly from huge collections of scientific texts without having to search for them manually across different platforms. The flexible architecture of the system ensures its scalability and compatibility with numerous database APIs thus enabling users to access the most recent and inclusive knowledge on their subjects of interest. Furthermore, integration with research portals allows users to keep, group, and cooperate on their literature reviews in a one-stop service thereby improving the research experience at large.

To facilitate intuitive interaction between researchers and the AI-based text analysis system, the user interface is crucial. The user interface is meant to be simple for all types of people whether they are professional or not. In addition, it has an efficient way of inputting research topics, specific papers of interest or keywords through a streamlined query mechanism. These queries are processed by the system which provides ranked lists of relevant papers together with their titles, authors, abstracts and publication dates. Additionally, this tool has advanced filter and sort features that help users to narrow down their search results depending on parameters like year of publication, citations and knowledge areas, among others. Besides this, the interface also integrates interactive visualizations like topic maps and citation networks that assist researchers in exploring relationships within literature over time. By so doing, these human-driven characteristics make it easy for individuals to use the service effectively hence enabling them to perform quick but comprehensive reviews of different journal articles as required by each writing task they have at hand.

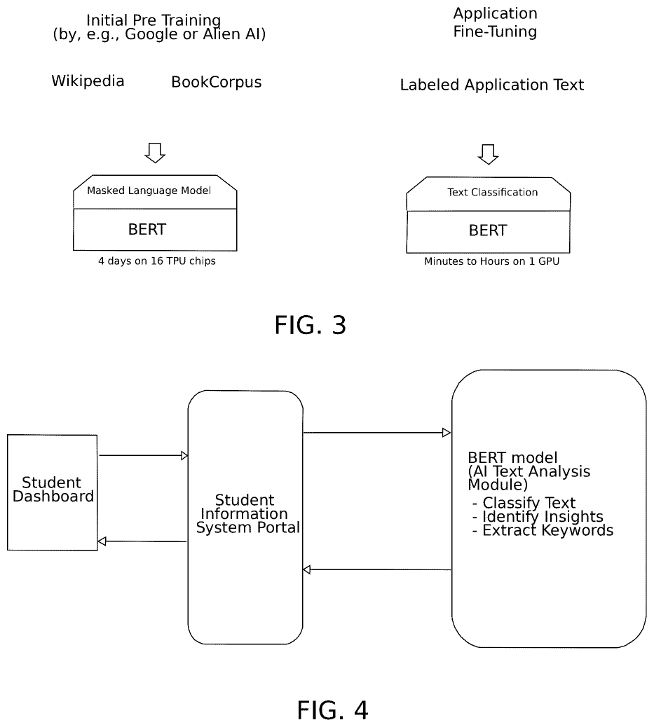

Referring to FIG. 3 shows the Bert Transfer Learning of the instant invention.

Referring to FIG. 4 shows how the AI-based text analysis system works. When the AI-based text analysis system uses BERT language model, it can effectively comprehend and analyze scholarly literature. In order to get the best out of BERT, a fine-tuning process is done using carefully chosen academic research and literature review from various fields.⁴ With this fine-tuning, the model is able to adjust its already known knowledge to the specific details and terminologies that are commonly used in academic writing. As such, by exposing BERT to different types of academic research texts, the program is able to realize domain-specific notions as well as citation styles and patterns that help it interpret and analyze research papers justly.

The query made by a user through the interface of this system is processed before being matched with indexed publications. Keyword matching, semantic similarity as well as citation analysis are some of the information retrieval techniques used by the system for identifying relevant papers based on user inputs. This means that the technique goes beyond simple keyword matching by considering the contextual meaning of the query at hand and the connection among papers so that they ensure relevance between the results retrieved and what a researcher wants for his or her study.

The system then makes use of BERT's language understanding capabilities to generate short summaries and extract major insights from entire articles. The summarization process entails condensing the most important information like research objectives, methods, results, and conclusions into a coherent summary. This helps readers understand the main aspects of each article in a brief review without going through the whole text. Furthermore, advanced mechanisms such as sentiment analysis and named entity recognition are employed by this system to extract useful information about key concepts, scientific contributions, and research trends which will enable researchers to have a good overview of the literature.

It is intuitive to the user via an attractive and well-designed dashboard where the resulting summaries and extracted insights are included in processed results. The ease of navigating through this interface allows researchers to access and browse through collected publications. To start with, it gives a clear layout for search results and even enables them to check out the entire text, original publication, or even export summaries and insights for further scrutiny. Moreover, it comes with interactive visualizations such as word clouds, citation networks, and topic clusters aimed at helping researchers see patterns, trends, and relationships within the literature. These representations enable users to understand better what is already known while facilitating connections between unrelated pieces of information that ultimately lead to a deeper understanding of the research context.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A platform for conducting academic research wherein said platform is comprised of:
Cloud infrastructure;
a web-based responsive interface accessible through browsers and mobile devices;
a display;
an API gateway;
a front end student information system;
a user dashboard;
a BERT model fine-tuned on academic and literature;
a server or servers;
a display;
a connection to academic databases; and
a processing unit managing;
data integration;
authentication and authorization;
load balancing;
containerization;
caching;
message queueing.

2. The platform of claim 1 which also includes the Bert model is fine-tune for adding searches for industry reports, articles and presentations.

3. The platform processing unit of claim 1 displaying visualizations of the relationships within the literature, examples are scatter charts, bar charts and bubble charts.

4. The platform of claim 1 where the BERT model is further fine-tuned through input through the user interface to understand academic language and jargon specific to various academic disciplines.

5. The platform and system of claim 1 where the processing unit further include a sentiment analysis module for identifying sentiments in the retrieved papers.

6. The platform and system of claim 1 the processing unit may further include a named entity recognition module for identifying entities such as datasets, methods, and algorithms in the retrieved papers.

7. The platform and system of claim 1 with searching capabilities in multiple languages, the language desired inputted through the user interface.

8. The platform and system of claim 1 where two part searches can appear, first for relevant data bases for the user to select from, and then a search of selected databases.

9. The platform and system of claim 1 processing unit further to provide most pertinent rankings on relevant papers, articles and presentations.

10. The platform and system of claim 1 where the user dashboard further includes a feature for refining search queries based on user feedback.

11. The feature for refining search queries of claim 10 includes a mechanism for adjusting the relevance of search results based on user interactions with the system.

12. A method for conducting academic research comprising:
student logs in through the dashboard the user interface;
student requests passes through API gateway and authentication server;
load balancer directs the request to an available application server;
a search query with keywords related to a specific academic discipline is entered into the platform and system;
application server process the request, interaction with the SIS (student information system) and academic databases as needed;
BERT AI module enhances search results and provides recommendations;
Dashboard is generated with personalized information\Response is sent back to user interface for display.

13. The method for conducting academic research of claim 12, relevant papers may further include sorting the retrieved papers based on relevance to the search query.

14. The method for conducting academic research of claim 12, the processing the retrieved papers will include identifying entities such as datasets, methods, and algorithms in the retrieved papers.

15. The method for conducting academic research of claim 12, the step of generating summaries further includes generating visual representations of relationships within the literature.

16. In the method for conducting academic research of claim 12, the BERT model may be further fine-tuned based on user input of the specific academic discipline related to the keywords in the search query.

17. The method for conducting academic research of claim 12, relevant papers may further include sorting the retrieved papers based on relevance to the search.
